(19) United States
(12) Patent Application Publication
(10) Pub. No.: US 2021/0368914 A1
(43) Pub. Date: Dec. 2, 2021

(54) Light-Up Speed Sensing Shoe Apparatus

(71) Applicant: Damon E Moye, Houston, TX (US)

(72) Inventor: Damon E Moye, Houston, TX (US)

(21) Appl. No.: 16/885,509

(22) Filed: May 28, 2020

(51) Int. Cl. A43B 13/14; G01P 3/12

(52) U.S. Cl. CPC A43B 13/14; G01P 3/12

(57) ABSTRACT

A light-up speed sensing shoe apparatus for tracking speed and motivating runners includes a shoe body, an outsole coupled to the shoe body, and an insole coupled to the outsole within the shoe body. An impact sensor is coupled within the outsole. The impact sensor detects a speed at which a wearer is running. A microprocessor is coupled within the outsole. The microprocessor is in operational communication with the impact sensor. A battery is coupled within the outsole and is in operational communication with the microprocessor. A plurality of lights is coupled to the outsole and is in operational communication with the microprocessor.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to running shoes and more particularly pertains to a new running shoe for tracking speed and motivating runners.

### (2) Description of Related Art including information disclosed under 37 CFR 1.97 and 1.98

The prior art relates to running shoes with various means of illumination. Most existing devices light up upon impact and blink with a predetermined pattern or length of time. Others require manual operation or are force sensitive to determine the illumination pattern. Existing devices do not illuminate only at a predetermined velocity to allow runners to signal once they have achieved speed goals.

### BRIEF SUMMARY OF THE INVENTION

An embodiment of the disclosure meets the needs presented above by generally comprising a shoe body, an outsole coupled to the shoe body, and an insole coupled to the outsole within the shoe body. An impact sensor is coupled within the outsole. The impact sensor detects a speed at which a wearer is running. A microprocessor is coupled within the outsole. The microprocessor is in operational communication with the impact sensor. A battery is coupled within the outsole and is in operational communication with the microprocessor. A plurality of lights is coupled to the outsole and is in operational communication with the microprocessor.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a light-up speed sensing shoe apparatus according to an embodiment of the disclosure.

FIG. 2 is a rear elevation view of an embodiment of the disclosure.

FIG. 3 is a side elevation view of an embodiment of the disclosure.

FIG. 4 is a bottom plan view of an embodiment of the disclosure.

FIG. 5 is an in-use view of an embodiment of the disclosure.

### DETAILED DESCRIPTION OF THE INVENTION

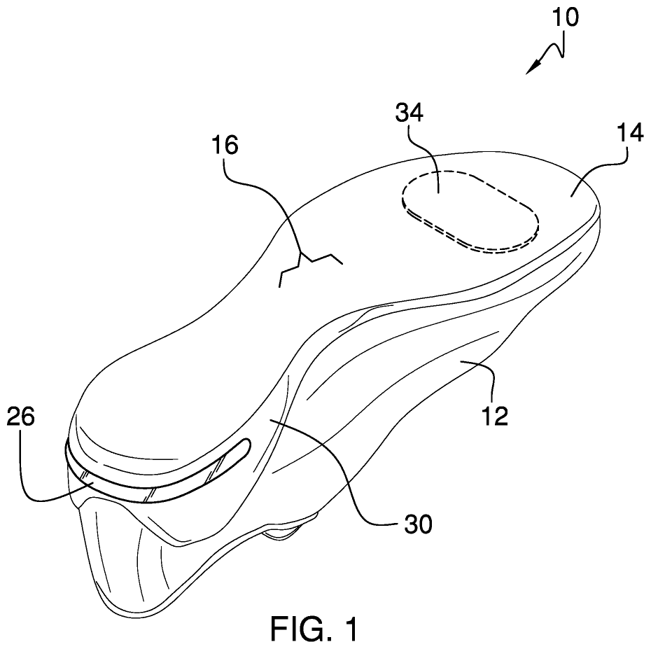

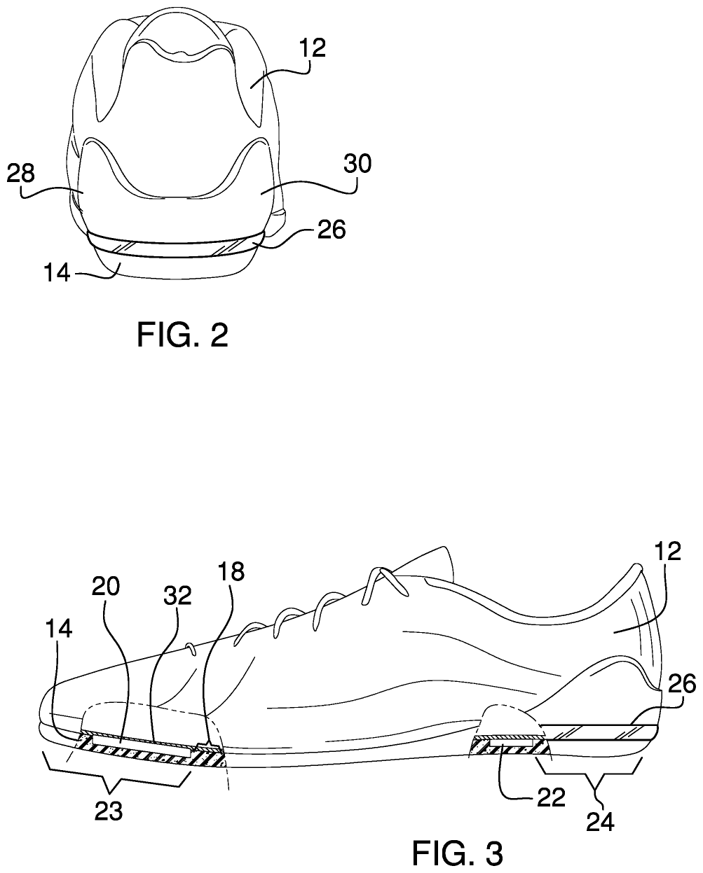

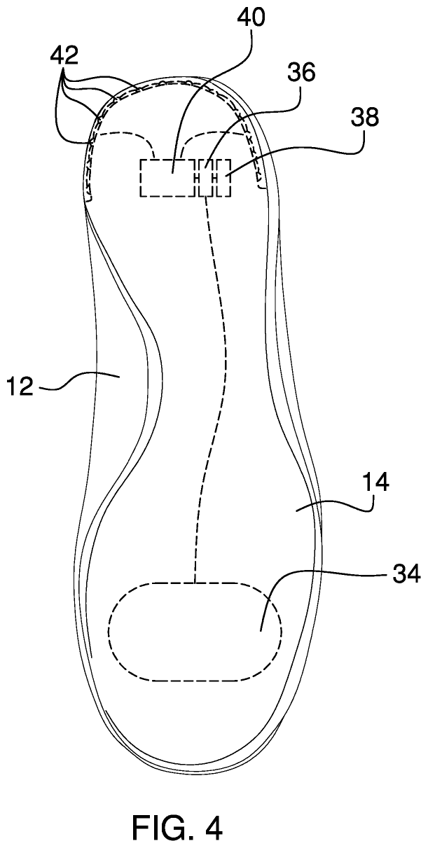

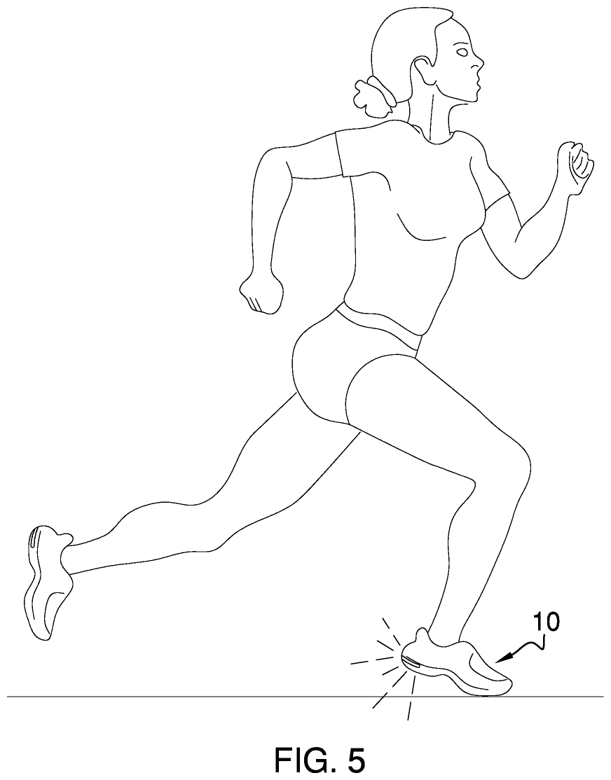

With reference now to the drawings, and in particular to FIGS. 1 through 5 thereof, a new running shoe embodying the principles and concepts of an embodiment of the disclosure and generally designated by the reference numeral 10 will be described.

As best illustrated in FIGS. 1 through 5, the light-up speed sensing shoe apparatus 10 generally comprises a shoe body 12. The shoe body 12 may be an athletic shoe such as, but not limited to, running shoes, track shoes, sports cleats, or the like. An outsole 14 is coupled to the shoe body 12. The outsole 14 has an outer face 16 and an inner face 18. The outer face 16 may have a patterned grip and may include fixed or removable spikes or cleats.

The inner face 18 may have a sensor cavity 20 and a battery cavity 22. The sensor cavity 18 is positioned proximal a toe portion 23 of the outsole. The outsole 14 has a heel portion 24 which may extend up the shoe body 12. There may be translucent section 26 within the heel portion 24. The translucent section 26 may be an obround shape extending from a lateral side 28 of the outsole to a medial side 30 of the outsole. An insole 32 is coupled to the outsole 14. The insole 32 may be removably disposed within the shoe body 12 to cover and alternatively expose the inner face 18 of the outsole 14.

An impact sensor 34 is coupled within the outsole 14. The impact sensor 34 detects a speed at which a wearer of the apparatus 10 is running. The impact sensor 34 may be coupled removably within the sensor cavity 20 and accessible by lifting the insole 32. The impact sensor 34 may thus be transferred to another apparatus once the shoe body 12 or the outer face 16 of the outsole have been worn out.

A microprocessor 36 is coupled within the outsole 14 and is in operational communication with the impact sensor 34. A transceiver 38 may be coupled within the outsole 14. The transceiver 38 is in operational communication with the microprocessor 36 and is configured to be in operational communication with an app on a smartphone. A battery 40 is coupled within the outsole 14 and is in operational communication with the microprocessor 36. The battery 40 may be removably coupled within the battery cavity 22 and accessible by lifting the insole 32 to be replaced as needed.

A plurality of lights 42 is coupled to the outsole 14. The plurality of lights 42 may be coupled within the outsole 14 adjacent the translucent section 26 to maximize visibility while remaining protected. The plurality of lights 42 is in operational communication with the microprocessor 36 to be activated once the impact sensor 34 detects the wearer has achieved a predetermined speed.

In use, the microprocessor 36 is programmed for a desired speed, either be being preprogrammed with a fixed speed or by being adjusted via the transceiver 38. When the apparatus 10 is worn while running and the impact sensor 34 detects the programmed speed, the plurality of lights 42 are illuminated to show the wearer, spectators, and other competitors.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A light-up speed sensing shoe apparatus comprising:
a shoe body;
an outsole coupled to the shoe body;
an insole coupled to the outsole within the shoe body;
an impact sensor coupled within the outsole, the impact sensor detecting a speed at which a wearer is running;
a microprocessor coupled within the outsole, the microprocessor being in operational communication with the impact sensor;
a battery coupled within the outsole, the battery being in operational communication with the microprocessor; and
a plurality of lights coupled to the outsole, the plurality of lights being in operational communication with the microprocessor.

2. The light-up speed sensing shoe apparatus of claim 1 further comprising the impact sensor being coupled proximal a toe portion of the outsole.

3. The light-up speed sensing shoe apparatus of claim 1 further comprising the outsole having an outer face and an inner face, the inner face having a sensor cavity and a battery cavity; the impact sensor being coupled within the sensor cavity and the battery being coupled within the battery cavity; the insole being removably disposed within the shoe body.

4. The light-up speed sensing shoe apparatus of claim 1 further comprising a transceiver coupled within the outsole, the transceiver being in operational communication with the microprocessor and being configured to be in operational communication with an app on a smartphone.

5. The light-up speed sensing shoe apparatus of claim 1 further comprising the outsole having a translucent section; the plurality of lights being coupled within the outsole adjacent the translucent section.

6. The light-up speed sensing shoe apparatus of claim 5 further comprising the outsole having a heel portion extending up the shoe body, the translucent section being within the heel portion.

7. The light-up speed sensing shoe apparatus of claim 6 further comprising the translucent section being an obround shape extending from a lateral side of the outsole to a medial side of the outsole.

8. A light-up speed sensing shoe apparatus comprising:
a shoe body;
an outsole coupled to the shoe body, the outsole having an outer face and an inner face, the inner face having a sensor cavity and a battery cavity, the sensor cavity being positioned proximal a toe portion of the outsole, the outsole having a heel portion extending up the shoe body and a translucent section within the heel portion, the translucent section being an obround shape extending from a lateral side of the outsole to a medial side of the outsole;
an insole coupled to the outsole, the insole being removably disposed within the shoe body;
an impact sensor coupled within the outsole, the impact sensor being coupled within the sensor cavity, the impact sensor detecting a speed at which a wearer is running;
a microprocessor coupled within the outsole, the microprocessor being in operational communication with the impact sensor;
a transceiver coupled within the outsole, the transceiver being in operational communication with the microprocessor and being configured to be in operational communication with an app on a smartphone;
a battery coupled within the outsole, the battery being coupled within the battery cavity and in operational communication with the microprocessor; and
a plurality of lights coupled to the outsole, the plurality of lights being coupled within the outsole adjacent the translucent section the plurality of lights being in operational communication with the microprocessor.
